(19) United States
(12) Patent Application Publication
(10) Pub. No.: US 2025/0045801 A1
(43) Pub. Date: Feb. 6, 2025

(54) PERSONALIZED VEHICLE CONTENT INCLUDING IMAGE BASED ON MOST PREFERRED VEHICLE

(71) Applicant: Capital One Services, LLC, McLean, VA (US)

(72) Inventors: Babu MANNAR, Little Elm, TX (US); Dhanansezhiyan SARAVANAN, Little Elm, TX (US); Thomas MARTIN, Rowlett, TX (US)

(21) Appl. No.: 18/365,297

(22) Filed: Aug. 4, 2023

(51) Int. Cl. G06Q 30/0251; G06V 10/75

(52) U.S. Cl. CPC G06Q 30/0269; G06Q 30/0255; G06V 10/75; G06V 2201/08

(57) ABSTRACT

In some implementations, a personalization system may track electronic activities associated with a user that relate to a prospective vehicle transaction for the user. The personalization system may identify, based on the electronic activities that relate to the prospective vehicle transaction, a most preferred vehicle associated with the user. The personalization system may identify, among a plurality of vehicle images, a vehicle image that is a closest match with respect to the most preferred vehicle. The personalization system may generate personalized content to include in a message to be sent to the user, wherein the personalized content includes the vehicle image that is the closest match with respect to the most preferred vehicle.

### BACKGROUND

Content personalization techniques involve tailoring digital content to individual users or specific segments of users based on their preferences, behavior, demographics, and/or other relevant data. Content personalization techniques aim to deliver a more relevant and engaging experience to users, increasing user satisfaction, engagement, and/or conversion rates. Among other techniques, content personalization may be achieved via user profiling to gather and analyze user data to understand user characteristics, preferences, and behavior, collaborative filtering to identify patterns of interest by collecting preferences or behavior data from a group of users and recommend items based on similarities in user preferences or behavior, and/or content-based filtering to recommend items to users based on the similarity between the content of the items and the profile or historical behavior of the user.

### SUMMARY

Some implementations described herein relate to a system for providing personalized vehicle content. The system may include one or more memories and one or more processors communicatively coupled to the one or more memories. The one or more processors may be configured to store a plurality of vehicle images in an image repository. The one or more processors may be configured to track electronic activities associated with a user that relate to a prospective vehicle transaction for the user. The one or more processors may be configured to identify, based on the electronic activities that relate to the prospective vehicle transaction, a most preferred vehicle associated with the user. The one or more processors may be configured to identify, among the plurality of vehicle images stored in the image repository, a vehicle image that is a closest match with respect to the most preferred vehicle. The one or more processors may be configured to generate personalized content to include in a message to be sent to the user, wherein the personalized content includes the vehicle image that is the closest match with respect to the most preferred vehicle. The one or more processors may be configured to send the message that includes the personalized content to the user.

Some implementations described herein relate to a method for generating personalized content. The method may include tracking, by a personalization system, electronic activities associated with a user that relate to a prospective vehicle transaction for the user. The method may include identifying, based on the electronic activities that relate to the prospective vehicle transaction, a most preferred vehicle associated with the user. The method may include identifying, by the personalization system, among a plurality of vehicle images stored in an image repository, a vehicle image that is a closest match with respect to the most preferred vehicle. The method may include generating, by the personalization system, personalized content to include in a message to be sent to the user, wherein the personalized content includes the vehicle image that is the closest match with respect to the most preferred vehicle.

Some implementations described herein relate to a non-transitory computer-readable medium that stores a set of instructions. The set of instructions, when executed by one or more processors of a system, may cause the system to track electronic activities associated with a user that relate to a prospective vehicle transaction for the user. The set of instructions, when executed by one or more processors of the system, may cause the system to identify, based on the electronic activities that relate to the prospective vehicle transaction, a most preferred vehicle associated with the user. The set of instructions, when executed by one or more processors of the system, may cause the system to search for a vehicle image that is a closest match with respect to the most preferred vehicle. The set of instructions, when executed by one or more processors of the system, may cause the system to generate personalized content to include in a message to be sent to the user, wherein the personalized content includes the vehicle image that is the closest match with respect to the most preferred vehicle. The set of instructions, when executed by one or more processors of the system, may cause the system to send the message that includes the personalized content to the user.

### BRIEF DESCRIPTION OF THE DRAWINGS

FIGS. 1A-1B are diagrams of an example implementation associated with personalized vehicle content including a vehicle image based on a most preferred vehicle, in accordance with some embodiments of the present disclosure.

FIG. 2 is a diagram illustrating an example of training and using a machine learning model in connection with personalized vehicle content including a vehicle image based on a most preferred vehicle, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of one or more devices of FIG. 2, in accordance with some embodiments of the present disclosure.

FIG. 5 is a flowchart of an example process associated with personalized vehicle content including a vehicle image based on a most preferred vehicle, in accordance with some embodiments of the present disclosure.

### DETAILED DESCRIPTION

The following detailed description of example implementations refers to the accompanying drawings. The same reference numbers in different drawings may identify the same or similar elements.

The vehicle buying journey has evolved significantly in recent years, now including many digital aspects that have transformed the way that people research, select, and enter into vehicle transactions. For example, starting from initial exploration to the final transaction, which may include a vehicle purchase or a lease, digital tools and platforms play an important role in enhancing the vehicle buying experience. For example, prospective buyers can utilize various online resources, such as manufacturer websites, online marketplaces, automotive review websites, and social media platforms to gather information about different vehicle models, specifications, features, pricing, and/or customer reviews, among other examples, which allows prospective buyers to compare options and make informed choices. In addition, many vehicle dealerships and/or manufacturers offer virtual showrooms or 360-degree tours that enable potential buyers to explore the interior and/or exterior of a vehicle that the potential buyers are considering without having to physically visit a vehicle dealership. Furthermore, online platforms often provide access to expert and user-generated vehicle reviews, video test drives, and walkthroughs, an ability to research financing options, calculate or model loan payments, and/or prequalify for vehicle loans through online portals or mobile applications offered by financial institutions, customize vehicles according to preferences (e.g., to select a desired color, trim level, optional features, and/or accessories), and/or to facilitate communication between buyers and sellers to help streamline the negotiation process, among other examples.

In order to help educate consumers that may be researching different vehicle models, specifications, technologies, safety features, performance, fuel efficiency, and/or other vehicle features, consumers may be provided with personalized (e.g., marketing) content in the form of detailed product descriptions, comparison guides, expert reviews, and/or user testimonials. In this way, the marketing content can help potential buyers to make informed decisions and narrow down vehicle choices based on their needs and preferences. Additionally, or alternatively, the personalized content may include information related to vehicle financing options, price comparisons, and/or other information that may help to streamline and increase the efficiency of the buying or leasing process. However, personalized vehicle content (e.g., marketing emails) typically contain relatively generic images based on a user preference that is determined from a vehicle that was last viewed by the user or a history of vehicles viewed by the user (e.g., a stock image of a vehicle associated with a specific year, make, model, trim, and color, or a specific type, such as an image of a sedan with a default color for all sedan preferences). In most cases, users have a very low interest in the generic images because the images often do not resemble the actual vehicle that the user is interested in, which can lead to minimal engagement in the personalized content. As a result, the user receiving the personalized content with the generic images may ignore or otherwise not take the educational and informative personalized content into consideration when contemplating a vehicle transaction, which may lead to wasted resources as the user performs duplicative or redundant research.

Some implementations described herein relate to techniques to provide personalized vehicle content to a user, where the personalized vehicle content includes one or more images that depict a vehicle that is a closest match with respect to a vehicle that is preferred by the user. For example, when the user engages in one or more electronic activities that relate to a prospective vehicle transaction, such as researching vehicles, prequalifying for a vehicle loan, or the like, the electronic activities may be tracked to determine one or more vehicles that the user is potentially interested in purchasing or leasing. Accordingly, in some implementations, a personalization system may identify, among the one or more vehicles that the user is potentially interested in purchasing or leasing, a vehicle that is most preferred by the user, and the personalization system may identify a vehicle image that is a closest match with respect to the most preferred vehicle. For example, the most preferred vehicle may be associated with a set of attributes, such as a year, make, model, trim, and color, and the personalization system may search for one or more images that depict a vehicle that exactly matches the set of attributes associated with the most preferred vehicle. Additionally, or alternatively, in cases where the personalization system is unable to locate an image that depicts a vehicle that exactly matches the set of attributes associated with the most preferred vehicle, the personalization system may search for images that depicts a vehicle that partially matches the set of attributes associated with the most preferred vehicle, where a combination of attributes that are searched for may be prioritized based on their relative importance to (e.g., searching for an image associated with a matching year, make, model, and trim in any color, and then searching for an image associated with a matching year, make, model, and color with any trim, and so on). Additionally, or alternatively, the personalization system may use a machine learning model to identify the image that is the closest match with respect to the most preferred vehicle. In this way, the personalization system can generate personalized content that includes information related to the most preferred vehicle, and the image that is the closest match with respect to the most preferred vehicle, which may improve the level of engagement with the personalized content and lead to a more resource-efficient car buying journey.

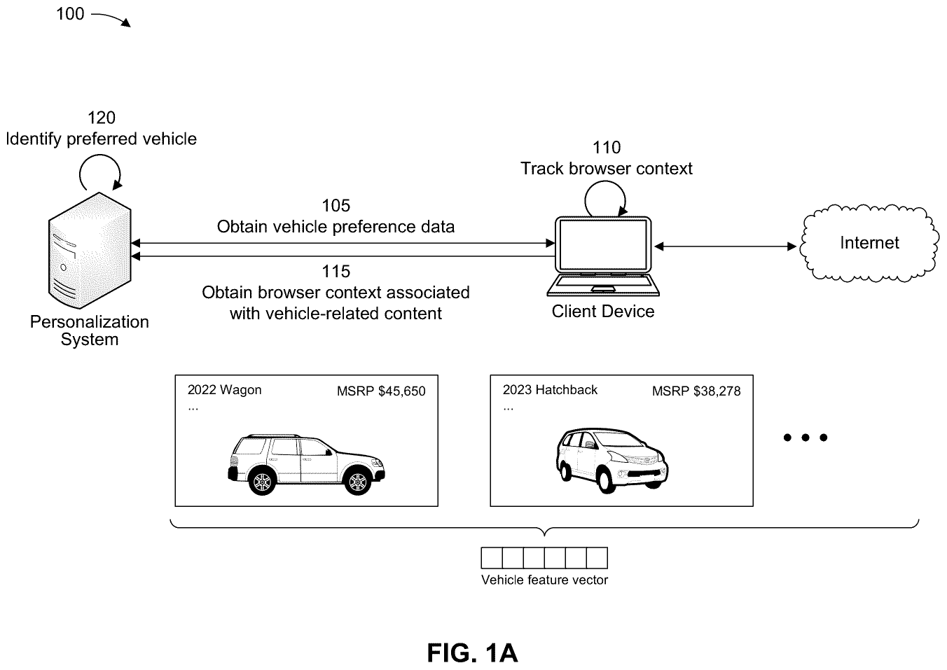

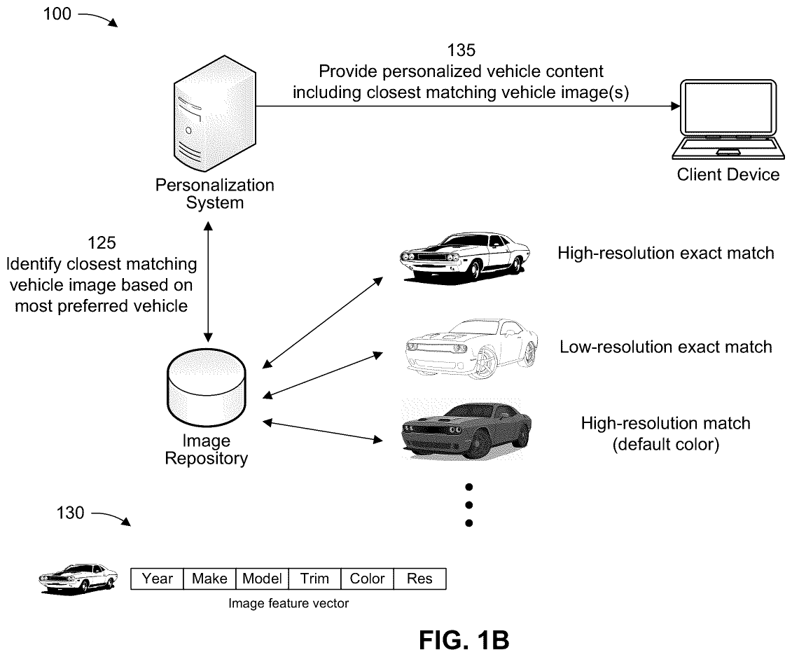

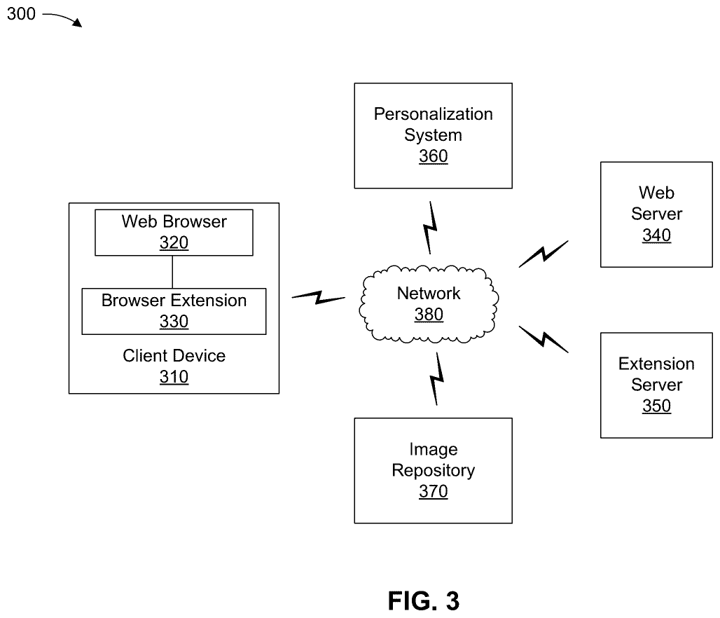

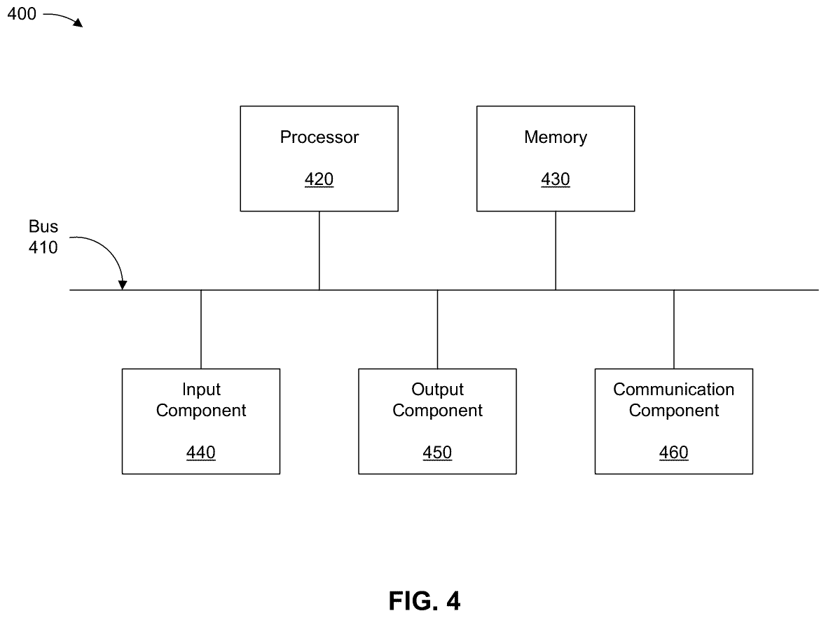

FIGS. 1A-1B are diagrams of an example 100 associated with personalized vehicle content including a vehicle image based on a most preferred vehicle. As shown in FIGS. 1A-1B, example 100 includes a client device, a personalization system, and an image repository. The client device, the personalization system, and the image repository devices are described in more detail in connection with FIG. 3 and FIG. 4.

As shown in FIG. 1A, and by reference number 105, the personalization system may obtain vehicle preference data from a user of the client device. For example, in some implementations, the personalization system may send information related to a questionnaire or survey to the client device (e.g., responsive to the user of the client device registering for a vehicle recommendation service), and the questionnaire or survey may be presented to the user via a user interface associated with the client device. For example, as described herein, the user interface may be associated with a vehicle recommendation application that executes on the client device, a website rendered in a browser of the client device, or the like. In some implementations, the user interface may be configured to present the user of the client device with information related to one or more recommended vehicles (e.g., images, descriptions, and/or attributes associated with the one or more recommended vehicles) such that the user may browse the collection of recommended vehicles. Furthermore, as described herein, the user interface may present the user of the client device with the questionnaire or survey from which the personalization system determines the vehicle preference data associated with the user. Furthermore, as described in further detail herein, the user interface may be configured to track, store, and/or convey information regarding a browser context associated with the user of the client device, including a historical viewing pattern including electronic activities related to browser interactions with content that relates to one or more vehicles that are of potential interest to the user, configuring a vehicle, modeling a loan for a vehicle, or the like.

In some implementations, as described herein, the personalization system may send information related to a questionnaire or survey to the client device, and may receive vehicle preference data from the user of the client device in the form of responses to the questionnaire or survey (e.g., the vehicle preference data may generally indicate a vehicle or one or more vehicle features that the user prefers). For example, in some implementations, the responses provided by the user may indicate one or more vehicle makes and/or one or more vehicle models that the user prefers. In another example, the responses provided by the user may indicate more granular information related to vehicle attributes that are preferred by the user. For example, the questionnaire or survey may include questions such as “How many people will usually ride in the car?,” “How often will you drive the car?,” “How far will you drive the car?,” or the like, and the user of the client device may provide responses to one or more of the questions to indicate the vehicle preference data. In some implementations, each question in the questionnaire or survey presented to the user may map to one or more vehicles and/or vehicle features or attributes. For example, the question “How many people will usually ride in the car?” may map to vehicle features or attributes such as body, style, number of seats, number of rows, or the like. In another example, the question “How far will you drive the car?” may map to vehicle features or attributes such as engine or motor type (e.g., gasoline, electric, or hybrid), fuel economy, or the like. In some implementations, the vehicle preference data may include user preferences directly provided by the user (e.g., a vehicle make and model, or direct answers for body, style, engine or motor, and/or other vehicle attributes or features). In some implementations, the vehicle preference data may include user preferences derived from answers to the questionnaire or survey, which may correspond to a particular vehicle, and/or may correspond to a particular vehicle feature. In some implementations, the personalization system may store the vehicle preference data in a data repository, which may also store vectorized information associated with each vehicle in a vehicle inventory. For example, the vehicle preference data and the vectorized information associated with the vehicles in the vehicle inventory may include information related to vehicle features or attributes such as year, make, model, trim, exterior color, fuel efficiency, mileage, price, engine or motor type, fuel type, drive train, body style, condition, and/or transmission, among other examples.

As further shown in FIG. 1A, and by reference number 110, the client device may be configured to track a browser context associated with the user of the client device. For example, in some implementations, a web browser executing on the client device may be configured to track the browser context while the user is browsing the Internet. For example, in some implementations, the web browser executing on the client device may be configured to run one or more client-side browser fingerprinting scripts (e.g., FingerprintJS, ImprintJS, or ClientJS) that can collect substantial diverse and stable information from the web browser, including a browser history or other electronic activities performed on the client devices (e.g., within mobile applications that may be separate from a web browser). Additionally, or alternatively, one or more browser extensions that are installed and executed within the web browser may be configured to generate a fingerprint related to electronic activities that occurs on the client device, where the browser extension(s) may have additional permissions or access to additional information that may provide more granularity and/or complexity to the fingerprint. For example, in some implementations, the browser context that is tracked on the client device may generally capture detailed information related to an environment in which document objects are presented on the client device (e.g., a tab, window, iframe, or frame associated with a web page may generally contain a browser context associated with a session history that lists one or more document objects that have been presented, are being presented, or will be presented within a browser context). Furthermore, a browser context may include information such as a creator browser context that indicates a parent or creator browser context that was responsible for creating the browser context, a child browser context that the browser context was responsible for creating, or a nested browser context when the browser context includes one or more elements that were instantiated within another browser context. Accordingly, as described herein, the browser context that is tracked by the client device may aggregate substantial information related to the browsing activity and/or browsing habits of the user of the client device, including browsing patterns, browsing histories, browsing sessions, navigation between different websites, resource loading, and/or event loops related to interactions between a script and a document object model (DOM). In general, the client device may be configured to track all browser activity on the client device (e.g., with the possible exception of incognito or private browsing or other activity that the user specifically requests to not be tracked) to derive a fingerprint based on historical patterns of browser interactions with content related to vehicles, metadata obtained from one or more services that indicates the creditworthiness of the user, and/or a profile associated with advertising content presented to the user (e.g., advertising impressions and/or click-throughs that are indicative of user interests).

As further shown in FIG. 1A, and by reference number 115, the personalization system may obtain (e.g., may receive from the client device) information related to the browser context of the client device, which may include information related to a historical pattern of electronic activities that include interactions with or related to vehicle-related content. For example, the electronic activities that are captured within the browser context may include information related to one or more browser sessions in which a user visited a vehicle dealer or manufacturer website to view information related to one or more vehicles or vehicle models, one or more sessions in which the user interacted with a vehicle dealer or manufacturer website to configure one or more options for a specific vehicle (e.g., trim levels or other customizations), one or more sessions in which the user chatted with personnel at a vehicle dealer to discuss a potential vehicle purchase, interactions with third-party websites or postings by third-party sellers of vehicles (e.g., auction websites such as eBay, social media postings on sites such as Facebook Marketplace, online classified advertisements in venues such as Craigslist, or the like), and/or general browser activity that includes interactions with vehicle-related content (e.g., visits to consumer report websites, vehicle review websites, vehicle comparison websites, or the like), among other examples. Furthermore, in some implementations, the browser context may include other sources of information that may relate to or otherwise impact which vehicles are potentially relevant to the user. For example, in some implementations, the browser context may include metadata from one or more websites associated with a financial institution (e.g., account balances, asset values, debts, credit scores, and/or other information that may indicate a creditworthiness or preferred loan configuration of the user) and/or AdSense information or other suitable information that indicates advertising impressions, click-throughs, or other information that may be relevant to vehicle preferences of the user. Additionally, or alternatively, financial information associated with the user may be obtained using other suitable techniques, such as a voluntary credit pull to which the user consents (e.g., by clicking or otherwise selecting a prequalification option on a website to create an association between the user and the browser context that the user consents to sharing) and/or the user self-configuring a preferred budget.

Accordingly, in some implementations, the personalization system may be configured to receive the browser context that includes the detailed browser fingerprint based on the historical pattern of the user performing browser interactions with content related to vehicles, services that indicate the financial status of the user, and/or advertising content presented to the user, among other examples. For example, in some implementations, the personalization system may search the browser context information to identify the N most recent vehicles viewed in the web browser, including any specific attributes associated with the N (e.g., five or ten) most recent vehicles viewed in the web browser. Additionally, or alternatively, the browser context may be used to derive a demographic profile associated with the user, including an age, gender, location, and/or creditworthiness of the user.

As further shown in FIG. 1A, and by reference number 120, the personalization system may identify a most preferred vehicle associated with the user. For example, in some implementations, the personalization system may identify a preferred vehicle dataset that includes one or more available vehicles based on the electronic activities that were performed using the client device. For example, in some implementations, the preferred system may use the browser context received from the client device, either alone or in combination with the vehicle preference data obtained from the user of the client device (e.g., responses to the questionnaire or survey), to generate a weighted feature dataset. In some implementations, as described herein, the weighted feature dataset may be represented as a vehicle feature vector that includes an array of elements, where each element in the array represents a particular vehicle attribute (e.g., a year, make, model, trim, exterior color, fuel efficiency, mileage, price, engine or motor type, fuel type, drive train, body style, condition, or transmission, among other examples). For example, in some implementations, the preferred system may generate the weighted feature dataset by mapping a portion of the browser context that is relevant to activities including interactions with or related to vehicle-related content to a browser-based vehicle preference dataset. In some implementations, the preferred system may also map the vehicle preference data derived from the questionnaire or survey responses to a user-specified vehicle preference dataset. Accordingly, as described herein, the browser-based vehicle preference dataset and the user-specified vehicle preference dataset may each be represented as a vehicle feature vector that includes an array of elements to represent the preference(s) of the user with respect to various vehicle attributes.

In some implementations, in cases where the preferred system uses the questionnaire or survey responses to generate the user-specified vehicle preference dataset, the responses that the user provided to each question presented in the questionnaire or survey may map to a set of vehicle attributes, and the preferred system may then aggregate sets of vehicle attributes to form the user-specified vehicle preference dataset. In some implementations, the user-specified vehicle preference dataset may have a different size and/or a different dimension than the browser-based vehicle preference dataset and/or the weighted feature set discussed in further detail elsewhere herein. For example, in cases where answers to two different questions map to two different sets of vehicle attributes (e.g., a first answer maps to a first set of vehicle attributes, such as {SUV, 6-cylinder, 2017}, and a second answer maps to a second set of vehicle attributes, such as {SUV, 8-cylinder, 2016, 2017}), the answers to the two questions may be aggregated to form a user-specified vehicle preference dataset expressed as {SUV: 2; 6-cylinder: 1; 8-cylinder: 1; 2016:1; 2017:2}. In some embodiments, the user-specified vehicle preference dataset may include a field for each possible vehicle attribute, and each field may have an integer value associated with the corresponding vehicle attribute. For example, the integer value may represent a frequency at which the questionnaire answers provided by the user are associated with a particular vehicle attribute. In some implementations, the integer value may be determined based on an indicated importance associated with a particular vehicle attribute, based on the questionnaire responses provided by the user. For example, if a user were to answer “Yes” to the question of “Will you regularly be carrying more than 2 people?” the user response may map to {SUV, SEDAN} (e.g., vehicles that can comfortably seat more than two people).

In some implementations, to map the browser context received from the client device to the browser-based vehicle preference dataset, the recommendation system may obtain the browsing history of a user on the user interface and determine vehicle attributes associated with one or more past or recently viewed vehicles based on subset of the browser interactions with content related to vehicles. For example, in some implementations, the personalization system may determine the vehicle attributes associated with the N past or recently viewed vehicles, where N may generally be a positive integer value (e.g., 1, 3, 5, 10, 20, 100, or another suitable quantity). For example, in some implementations, the personalization system may analyze the browser history or browsing habits recorded in the browser context to identify vehicles that the user viewed based on interactions with known vehicle manufacturer or dealer websites, consumer report websites, vehicle research websites, vehicle valuation websites, used car websites, or the like. Additionally, or alternatively, the vehicles viewed by the user may be determined based on interactive sessions in which the user configured or explored different combinations of vehicle attributes (e.g., configuring the same vehicle with a V4 and a V6 engine) and/or advertising impressions or advertising click-throughs (e.g., an advertising impression may indicate one or more vehicle attributes that an advertising system determined to be potentially relevant to the interests of the user, and an advertising click-through may indicate one or more vehicle attributes that are confirmed to be relevant to the interests of the user).

Additionally, or alternatively, the browser context may include a browser history related to interactions with one or more financial service providers, which may be indicative of a potential price range that the user is interested in (e.g., based on the user modeling a potential vehicle loan, applying to pre-qualify for a vehicle loan, and/or self-configuring budget information, among other examples). Additionally, or alternatively, the interactions with financial service providers may indicate a financial status of the user (e.g., based on a credit score, credit history, credit usage, payment history, available credit, income, or other factors related to the user's ability to finance a vehicle, which may be available to the personalization system based on a soft credit pull and/or based on the user holding one or more accounts with a financial institution associated with the personalization system). For example, in some implementations, the personalization system may be configured to provide recommended loan structuring information, such as an indication that the user would qualify to purchase or lease a vehicle with a given monthly payment over a given term (e.g., a number of months or years), which may be based on a credit pull or other information related to a creditworthiness of the user. In another example, the personalization system may gather information related to the financial status of the user from the available browser context, and may request that the user consent to a credit pull that would then be used to provide reliable prequalification information that could be used to provide accurate recommended loan structuring information. Additionally, or alternatively, the recommended loan structuring information may be independent of actual creditworthiness information (e.g., may be based on any suitable financial status information that can be harvested from the browser context), and may be used to prequalify the user for certain financing options, and/or to estimate or predict financing terms that would likely be affordable for the user or feasible to be financed from a lender. Further, in some implementations, the browser context that is used to derive the browser-based vehicle preference dataset may include information related to one or more browser interactions with a micro-frontend widget or other suitable application that may be running on a vehicle seller's website. For example, as described herein, a micro-frontend widget may generally refer to a user-facing component that can be tested, deployed, and updated separately from a website that may be running the micro-frontend widget. In this context, a vehicle dealer website may include a micro-frontend widget to enable a user to model or apply for financing on a specific vehicle listed on the vehicle dealer website. Accordingly, the metadata associated with the interaction(s) with the micro-frontend widget may provide further insight into the vehicle preferences and/or creditworthiness of the user.

In some implementations, based on the browser context received from the client device, the personalization system may determine one or more vehicle attributes for each browser interaction with content related to a vehicle or content relevant to purchasing a vehicle (e.g., financial metadata that may not have any relationship to a specific vehicle or vehicle attribute). For example, a browser interaction with content related to a 2022 Volvo V90 Cross Country may map to: {Wagon, 4-Cylinder, 2022}. Similar to the process described above with respect to the user-specified vehicle preference dataset, the set of vehicle attributes for each of the past or recently viewed vehicles may be aggregated in the browser-based vehicle preference dataset. For example, if a user viewed two SUVs in succession on the user interface, where the first browser interaction is with a 2016 model with a 6-cylinder engine and the second browser interaction is with a 2017 model with an 8-cylinder engine, the browser-based vehicle preference dataset may be represented as: {SUV: 2; 6-cylinder: 1; 8-cylinder: 1; 2016:1; 2017:1}. In some implementations, the browser-based vehicle preference dataset may include a field for each possible vehicle attribute and may have an integer value associated with each vehicle attribute, where the integer value may represent the frequency at which a particular vehicle attribute appeared in the browsing context of the user.

In some implementations, to generate the weighted feature dataset, the personalization system may determine an influence factor to apply to each vehicle attribute included in the browser-based vehicle preference dataset and/or the user-specified vehicle preference dataset. Based on the influence factor applied to each vehicle attribute, the weighted feature dataset may aggregate the browser-based vehicle preference dataset and/or the user-specified vehicle preference dataset in accordance with the determined influence factor to form the weighted feature dataset. For example, the influence factor may be represented as a multiplicative factor, percentage, and/or weighting that represents a degree to which a preference indicated in the browser-based vehicle preference data (e.g., based on browser context) or the user-specified vehicle preference data (e.g., based on explicit or implicit user questionnaire or survey answers) better represents of the user's true preferences that are used to form the basis of the vehicle preferences determined by the personalization system. For example, the user may be a car enthusiast who visits websites for high-end luxury vehicles that are well outside the user's financial means, and may provide questionnaire answers indicating a preference to potentially purchase a more modestly priced vehicle. In this example, when providing personalized content related to vehicles for the user to potentially purchase or lease, the influence factor may weigh the vehicle attributes indicated in the user-specified vehicle preference dataset more heavily than the vehicle attributes indicated in the browser-based vehicle preference dataset. In some implementations, generating the weighted feature dataset may include initially populating the weighted feature dataset based on the browser-based vehicle preference dataset and then refining the weighted feature dataset based on the user-specified vehicle preference dataset. In such cases, the browser-based and user-specified vehicle preference datasets may be aggregated to generate the weighted feature dataset. Alternatively, in some implementations, the weighted feature dataset may be based only on the browser-based vehicle preference dataset.

In some implementations, the weighted feature dataset may be represented as a vehicle feature vector that includes an array of elements, each of which represents a particular vehicle attribute. Furthermore, in some implementations, the array corresponding to the vehicle feature vector may include one or more elements for each possible vehicle attribute that the personalization system evaluates when generating personalized vehicle content. For example, in some implementations, the vehicle feature vector may include an array with elements to represent vehicle attributes that include a year, make, model, fuel efficiency, mileage, price, engine, diesel, gasoline, flexible-fuel, hybrid, electric, front wheel drive, rear wheel drive, all-wheel drive, four-wheel drive, two-wheel drive, white, brown, yellow, gold, black, gray, silver, red, blue, green, orange, bronze, beige, purple, burgundy, pink, turquoise, convertible, couple, hatchback, sedan, SUV, pickup, minivan, van, wagon, new, used, automatic, and/or manual, among other examples.

In some embodiments, as described herein, the vehicle feature vector may generally include one or more elements to represent each possible vehicle attribute that the personalization system evaluates when generating a preferred vehicle dataset. However, some vehicle attributes may be represented using only one element, while others may be represented using multiple elements to represent different choices or options for the corresponding attribute. For example, the vehicle feature vector may include one element to represent vehicle attributes such as a fuel efficiency, mileage, price, engine, year, or other attribute that can only have one value. Furthermore, the vehicle feature vector may include multiple elements to represent vehicle attributes that can have different values, such as a fuel type (e.g., including elements for diesel, gasoline, flexible-fuel, hybrid, or electric), exterior color (e.g., including elements for white, brown, yellow, gold, black, gray, silver, red, blue, green, orange, bronze, beige, purple, burgundy, pink, turquoise), drive type (e.g., including elements for front wheel drive, rear wheel drive, all-wheel drive, four-wheel drive, or two-wheel drive), body style (e.g., including elements for convertible, coupe, hatchback, sedan, SUV, pickup, minivan, van, or wagon), condition (e.g., including elements for new or used), and/or transmission (e.g., including elements for automatic or manual), among other examples.

In some embodiments, vehicle attributes that are represented in the vehicle feature vector using one element only may have a value between 0 and 1. For example, a range of possible fuel efficiencies may be mapped to values between 0 and 1 (e.g., with 1 being the most fuel-efficient and 0 being the least fuel-efficient). In another example, for body style, a convertible may be expressed as 0.22, a coupe may be expressed as 0.29, a sedan may be expressed as 0.36, a hatchback may be expressed as 0.43, a wagon may be expressed as 0.5, an SUV may be expressed as 0.57, a pickup may be expressed as 0.64, a minivan may be expressed as 0.71, and a van may be expressed as 0.78. In another example, for an engine, a 2-cylinder may map to 0.15, a 4-cylinder to 0.29, 6-cylinder to 0.43, and 10-cylinder to 0.71. In some implementations, different engine options from the browser-based and/or user-specified vehicle preference datasets may be averaged to form the weighted feature dataset. For example, if the weighted feature dataset has a value of 3 associated with a 4-cylinder engine and a value of 2 associated with a 6-cylinder engine, the averaged value in the engine element of the vehicle feature vector becomes (3*0.15+2*0.29)/5. In some embodiments, the mapping to values between 0 and 1 may capture similarities between entries. For example, a 2-cylinder engine that is expressed as 0.15 may be more similar to a 4-cylinder engine expressed as 0.43 than a 10-cylinder engine expressed as 0.71.

In some implementations, the personalization system may use the techniques described herein to generate the vehicle feature vector based on the browser-based vehicle preference dataset or based on a combination of the browser-based and user-specified vehicle preference datasets. The personalization system may then apply a similarity model to the vehicle feature vector to generate a preferred vehicle dataset based on the vehicle feature vector. For example, any suitable similarity model or technique may be used to generate the preferred vehicle dataset based on a comparison between the vehicle feature vector that is based at least in part on the user's vehicle preferences that are determined from the user's browser context and vectorized information associated with each vehicle in a vehicle inventory associated with the personalization system (e.g., vehicles that are available to purchase from a dealer, manufacturer, or other seller associated with the personalization system). In some implementations, the vectorized information associated with the vehicles in the vehicle inventory may be expressed in the same or a similar manner as the vehicle feature vector based on the user's vehicle preferences in order to facilitate application of the similarity model.

For example, in some implementations, the similarity model may be a cosine similarity model. In some implementations, the cosine similarity model may be configured to minimize the cosine distance between the vehicle feature vector derived from the weighted feature dataset and a vehicle represented as a vector. In some implementations, the personalization system may perform cosine distance calculations between the vehicle feature vector based on the user's preferences and each vector that represents a vehicle available in a vehicle inventory. In this manner, a vehicle in the vehicle inventory having a set of attributes most similar to the vehicle feature vector may be determined by the personalization system. In some implementations, applying the similarity model to the vehicle feature vector to determine the preferred vehicle dataset may include generating a feature representation for each vehicle in the vehicle inventory based on a set of attributes associated with the respective vehicles, determining one or more similarity values between the feature representations for each respective vehicle and the vehicle feature vector representing the user's preferences, and selecting one or more vehicles corresponding to a subset of the feature representations having the closest determined similarity values (e.g., the lowest cosine distances). As a result, a value between 0 and 1 may be associated with each vehicle in the vehicle inventory, where the vehicles associated with relatively greater values (closer to 1) are representative of vehicles that are more similar to the ideal vehicle represented by the vehicle feature vector derived, at least in part, from the browser context associated with the client device. In this way, the personalization system may identify a particular set of attributes associated with a vehicle that is most preferred by the user, such as a combination of a year, make, model, trim, and color.

As shown in FIG. 1B, and by reference number 125, the personalization system may identify, among various images that are stored in an image repository, one or more images that are a closest match with respect to the vehicle that is most preferred by the user. For example, as shown by reference number 130, each image in the image repository may be associated with a set of attributes or features (e.g., in the form of an image feature vector or other suitable metadata), which may include a year, a make, a model, a trim, and a color of the vehicle depicted in the image. Furthermore, in some implementations, the set of attributes or features may include one or more elements related to the image, such as a resolution of the image, an image format (e.g., a joint photographic experts group (JPEG) format, a portable network graphics (PNG) format, or the like), and/or other suitable image attributes. Additionally, or alternatively, the set of attributes or features may indicate a view associated with the image, such as whether the image depicts a front view of a vehicle exterior, a side view of a vehicle exterior, a vehicle interior, or another suitable view of the vehicle. In some implementations, the various images in the image repository may correspond to stock images that the personalization system gathers from one or more image sources, new or used vehicles that are offered for sale through one or more dealerships or manufacturers, vehicles that are depicted on websites, articles, or other online sources, or the like, and the various attributes or features associated with one or more of the images may be defined in metadata associated with the source image. Additionally, or alternatively, the personalization system may use one or more machine learning techniques, such as a computer vision technique, to derive one or more of the attributes or features associated with the images in the image repository. For example, the personalization system may obtain a vehicle image that is associated with metadata indicating that the make and model of the depicted vehicle is a Honda Accord associated with an EX trim level, and may use computer vision techniques to determine the color of the depicted vehicle and/or the year of the depicted vehicle (e.g., based on distinctive design features). Furthermore, although some implementations are described herein as storing the various vehicle images in an image repository, the personalization system may be configured to search online data sources for vehicle images without storing the images in the image repository.

In some implementations, to identify the image that is the closest match with respect to the vehicle that is most preferred by the user, the personalization system may identify a combination of attributes that impact the physical appearance of the most preferred vehicle. For example, in some implementations, the combination of attributes that impact the physical appearance of the most preferred vehicle may include a year, a make, a model, a trim, and a color. Accordingly, to identify the image that is the closest match with respect to the vehicle that is most preferred by the user, the personalization system may initially search for one or more images that depict a vehicle associated with a set of features or attributes that exactly match the combination of attributes that impact the physical appearance of the most preferred vehicle. For example, the personalization system may search for one or more images that depict vehicles associated with the same year, make, model, trim, and color as the most preferred vehicle.

In cases where more than one image depicts a vehicle associated with the same year, make, model, trim, and color as the most preferred vehicle, the personalization system may select an image associated with a highest resolution (e.g., an exact match associated with a 1280×960 resolution may be ranked higher than an exact match associated with a 640×480 resolution). Additionally, or alternatively, in cases where more than one image depicts a vehicle associated with the same year, make, model, trim, and color as the most preferred vehicle, the personalization system may select an image associated with a preferred view of the vehicle (e.g., a view depicting the vehicle at an angle such that the front and side of the vehicle is visible may be ranked higher than a front view that depicts the vehicle head-on or a side view that only depicts the side of the vehicle). Additionally, or alternatively, the preferred view of the vehicle may be assigned more weight than one or more of the combination of attributes (e.g., an image depicting a front/side view of vehicle that is a partial match, such as the same year, make, model, and trim but a different color from the most preferred vehicle may be ranked higher than an image depicting only a side view of a vehicle that is an exact match for the year, make, model, trim, and color of the most preferred vehicle).

In some implementations, in cases where the personalization system is unable to find an image that depicts a vehicle associated with a set of features or attributes that is an exact match for the most preferred vehicle, the personalization system may search the available vehicle images for one or more images that match a prioritized subcombination of the features associated with the most preferred vehicle. For example, if the personalization system is unable to locate an image that matches the full combination of features associated with the most preferred vehicle, the personalization system may then search for an image depicting a vehicle with the same year, make, model, and trim and a default color (e.g., white), which may be returned as the closest match if found. However, if the personalization system is still unable to locate an image that depicts a vehicle with the same year, make, model, and trim, the personalization system may search for other subcombinations of features that do not include one or more of the features of the most preferred vehicle in order to broaden and expand the range of potentially matching vehicle images. For example, if the personalization system cannot find an image that depicts a vehicle that is an exact match for the combination of features associated with the most preferred vehicle or a partial match for a subcombination of features that does not include exterior color, the personalization system may search for an image that depicts a vehicle associated with the same year, make, and model, in any trim or color (e.g., trim and color are not included in the searched subcombination of features). In cases where the personalization system identifies multiple matches for the subcombination of features, the search results may be refined to identify the image with the highest resolution, the image for which the color is a closest match to the color of the most preferred vehicle (e.g., an image depicting a white vehicle may be a closer match to a preferred silver vehicle relative to an image depicting a red vehicle), and/or the image for which the trim level is closest to the trim level of the most preferred vehicle (e.g., if the most preferred vehicle is associated with a highest trim levels, and the year, make, and model of the most preferred vehicle is associated with four possible trim levels, the second-highest trim level may be considered closer to the most preferred vehicle than the lowest or second-lowest trim).

Furthermore, in some implementations, the personalization system may continue to search for images associated with different subcombinations of features that match corresponding features of the most preferred vehicle when images associated with (narrower) subcombinations of features cannot be found. For example, if there are no images in the image repository or other available image sources that depict a vehicle associated with the same year, make, and model as the most preferred vehicle, the personalization system may search for images depicting vehicles from earlier years that are associated with the same make, model, trim, and color (e.g., based on vehicles from earlier years associated with the same make, model, trim, and color being likely to have the same or similar appearance as the year of the most preferred vehicle). Additionally, or alternatively, in cases where the most preferred vehicle is a used vehicle that is associated with an earlier year (e.g., not the current or most recent year of a new vehicle), the personalization system may search for images depicting vehicles in later years that have the same make, model, trim, and/or color as the most preferred vehicle. Furthermore, in cases where the personalization system is unable to identify images that depict vehicles from earlier or later years that are associated with the same make, model, trim, and/or color as the most preferred vehicle, the personalization system may then search for images that depict vehicles associated with different models but the same body style (e.g., sedan or SUV) and the same subcombination of features that includes a year, make, trim, and/or color. In some implementations, if the personalization system is still unable to identify an image that depicts a vehicle associated with a suitable combination or subcombination of features that matches a combination or subcombination of features associated with the most preferred vehicle, the personalization system may identify a default image associated with the year, make, model, trim, and color of the most preferred vehicle as the image that is the closest match.

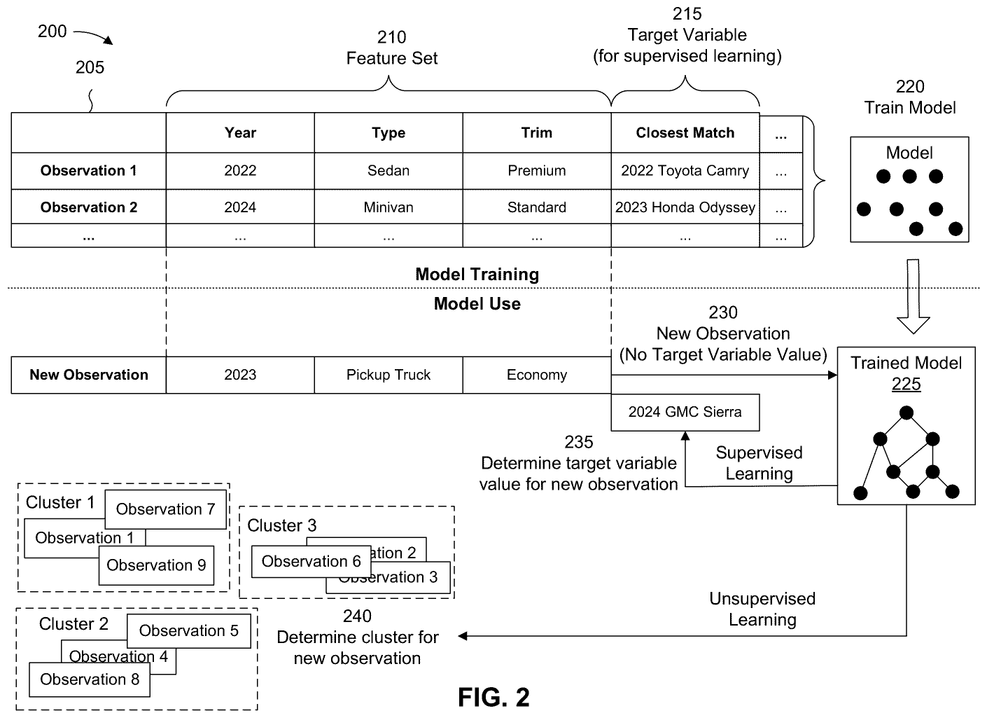

In some implementations, as described herein, the personalization system may generally search for one or more vehicle images that are associated with a combination or subcombination of features that match a combination or subcombination of features associated with the most preferred vehicles, where the features or attributes that are included in the searched subcombination of features may be prioritized to assign more weight to certain features (e.g., color may be deprioritized when searching for a subcombination of features that includes a year, make, model, and trim). However, in some implementations, the particular priorities that are assigned to the various features may vary depending on user preferences or other suitable factors. For example, in some implementations, the personalization system may prioritize finding an image that depicts a vehicle that matches the color of the most preferred vehicle in cases where there is a minimal or insubstantial change in the body design of a vehicle over a certain time period. Additionally, or alternatively, in some implementations, the personalization system may use machine learning techniques (e.g., as described below with respect to FIG. 2) to identify the image that is the closest match with respect to the most preferred vehicle of the user.

As further shown in FIG. 1B, and by reference number 135, the personalization system may then generate a message that includes personalized vehicle content associated with the user, where the personalized vehicle content may include the image that was identified as the closest match with respect to the most preferred vehicle of the user, and the message may be sent to the user of the client device. For example, in some implementations, the personalized vehicle content may include educational or informative content related to the most preferred vehicle and/or one or more recommended or suggested vehicles that may be similar to the most preferred vehicle (e.g., to enable comparison shopping). Additionally, or alternatively, the personalized vehicle content may include financing options, promotional offers, purchase versus lease information, and/or other suitable information that may be relevant to informing the user's decision making for a prospective vehicle transaction. In some implementations, as described herein, the message that includes the personalized vehicle content, including the image depicting a vehicle that is the closest match with respect to the most preferred vehicle of the user, may include an email message, a text message (e.g., a short message service (SMS) message, a multimedia message service (MMS) message, or an application-specific message), direct mail material, a web notification or application-specific notification, or the like. In this way, by including the image of the vehicle that is the closest match with respect to the most preferred vehicle of the user, the personalization system can may increase the level of engagement that the user has with the personalized content, which may lead to a more resource-efficient car buying journey for a prospective vehicle transaction.

As indicated above, FIGS. 1A-1B are provided as an example. Other examples may differ from what is described with regard to FIGS. 1A-1B.

FIG. 2 is a diagram illustrating an example 200 of training and using a machine learning model in connection with personalized vehicle content including a vehicle image based on a most preferred vehicle. The machine learning model training and usage described herein may be performed using a machine learning system. The machine learning system may include or may be included in a computing device, a server, a cloud computing environment, or the like, such as the personalization system described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from the personalization system and/or one or more client devices, as described elsewhere herein.

As shown by reference number 210, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the personalization system and/or one or more client devices. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of year, a second feature of type, a third feature of trim, and so on. As shown, for a first observation, the first feature may have a value of 2022, the second feature may have a value of sedan, the third feature may have a value of premium, and so on. These features and feature values are provided as examples, and may differ in other examples. For example, the feature set may include one or more of the following features: make, model, color, resolution, and/or view, among other examples, which may include features or attributes of a vehicle that is most preferred by a user.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is closest match, which has a value of 2022 Toyota Camry for the first observation.

The feature set and target variable described above are provided as examples, and other examples may differ from what is described above.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of 2023, a second feature of pickup truck, a third feature of economy, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of 2024 GMC Sierra for the target variable of closest match for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, a recommendation that a user evaluate the specifications, price, or other features of a vehicle depicted in an image that is predicted to be a closest match with respect to the vehicle that is most preferred by the user. The first automated action may include, for example, generating personalized content that includes the image depicting the vehicle that is predicted to be a closest match with respect to the vehicle that is most preferred by the.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., exact matches), then the machine learning system may provide a first recommendation, such as the first recommendation described above. Additionally, or alternatively, the machine learning system may perform a first automated action and/or may cause a first automated action to be performed (e.g., by instructing another device to perform the automated action) based on classifying the new observation in the first cluster, such as the first automated action described above.

As another example, if the machine learning system were to classify the new observation in a second cluster (e.g., partial matches associated with a different color or trim level), then the machine learning system may provide a second (e.g., different) recommendation (e.g., suggesting that the user consider alternative color or trim options) and/or may perform or cause performance of a second (e.g., different) automated action, such as generating personalized content that indicates pricing differences for vehicles that are associated with different color or trim options.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

The recommendations, actions, and clusters described above are provided as examples, and other examples may differ from what is described above.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model). For example, the feedback information may include information that relates to user engagement with the personalized content, such as selecting one or more links that are present in the personalized content, scrolling through the personalized content, or the like.

In this way, the machine learning system may apply a rigorous and automated process to identify one or more images depicting vehicles that are a closest match with respect to a vehicle that is most preferred by a user. The machine learning system may enable recognition and/or identification of tens, hundreds, thousands, or millions of features and/or feature values for tens, hundreds, thousands, or millions of observations, thereby increasing accuracy and consistency and reducing delay associated with identifying one or more images depicting vehicles that are a closest match with respect to a vehicle that is most preferred by a user relative to requiring computing resources to be allocated for tens, hundreds, or thousands of operators to manually identify images depicting vehicles that are relevant to a vehicle that is most preferred by a user using the features or feature values.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include a client device 310 (e.g., which may execute a web browser 320 and a browser extension 330), a web server 340, an extension server 350, a personalization system 360, an image repository 370, and a network 380. Devices of environment 300 may interconnect via wired connections, wireless connections, or a combination of wired and wireless connections.

The client device 310 may include a device that supports web browsing. For example, the client device 310 may include a computer (e.g., a desktop computer, a laptop computer, a tablet computer, and/or a handheld computer), a mobile phone (e.g., a smart phone), a television (e.g., a smart television), an interactive display screen, and/or a similar type of device. The client device 310 may host a web browser 320 and/or a browser extension 330 installed on and/or executing on the client device 310.

The web browser 320 may include an application, executing on the client device 310, that supports web browsing. For example, the web browser 320 may be used to access information on the World Wide Web, such as web pages, images, videos, and/or other web resources. The web browser 320 may access such web resources using a uniform resource identifier (URI), such as a uniform resource locator (URL) and/or a uniform resource name (URN). The web browser 320 may enable the client device 310 to retrieve and present, for display, content of a web page.

The browser extension 330 may include an application, executing on the client device 310, capable of extending or enhancing functionality of the web browser 320. For example, the browser extension 330 may be a plug-in application for the web browser 320. The browser extension 330 may be capable of executing one or more scripts (e.g., code, which may be written in a scripting language, such as JavaScript) to perform an operation in association with the web browser 320.

The web server 340 may include a device capable of serving web content (e.g., web documents, HTML documents, web resources, images, style sheets, scripts, and/or text). For example, the web server 340 may include a server and/or computing resources of a server, which may be included in a data center and/or a cloud computing environment. The web server 340 may process incoming network requests (e.g., from the client device 310) using HTTP and/or another protocol. The web server 340 may store, process, and/or deliver web pages to the client device 310. In some implementations, communication between the web server 340 and the client device 310 may take place using HTTP.

The extension server 350 may include a device capable of communicating with the client device 310 to support operations of the browser extension 330. For example, the extension server 350 may store and/or process information for use by the browser extension 330. As an example, the extension server 350 may store a list of domains applicable to a script to be executed by the browser extension 330. In some implementations, the client device 310 may obtain the list (e.g., periodically and/or based on a trigger), and may store a cached list locally on the client device 310 for use by the browser extension 330.

The personalization system 360 may include one or more devices capable of receiving, generating, storing, processing, providing, and/or routing information associated with personalized vehicle content including a vehicle image based on a most preferred vehicle, as described elsewhere herein. The personalization system 360 may include a communication device and/or a computing device. For example, the personalization system 360 may include a server, such as an application server, a client server, a web server, a database server, a host server, a proxy server, a virtual server (e.g., executing on computing hardware), or a server in a cloud computing system. In some implementations, the personalization system 360 may include computing hardware used in a cloud computing environment.

The image repository 370 may include one or more devices capable of receiving, generating, storing, processing, and/or providing information associated with personalized vehicle content including a vehicle image based on a most preferred vehicle, as described elsewhere herein. The image repository 370 may include a communication device and/or a computing device. For example, the image repository 370 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the image repository 370 may store various images, each of which depicts a vehicle associated with a set of features or attributes (e.g., a year, make, model, trim level, and/or color (, as described elsewhere herein.

The network 380 may include one or more wired and/or wireless networks. For example, the network 380 may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400 associated with personalized vehicle content including. The device 400 may correspond to the client device 310, the web server 340, the extension server 350, the personalization system 360, and/or the image repository 370. In some implementations, the client device 310, the web server 340, the extension server 350, the personalization system 360, and/or the image repository 370 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

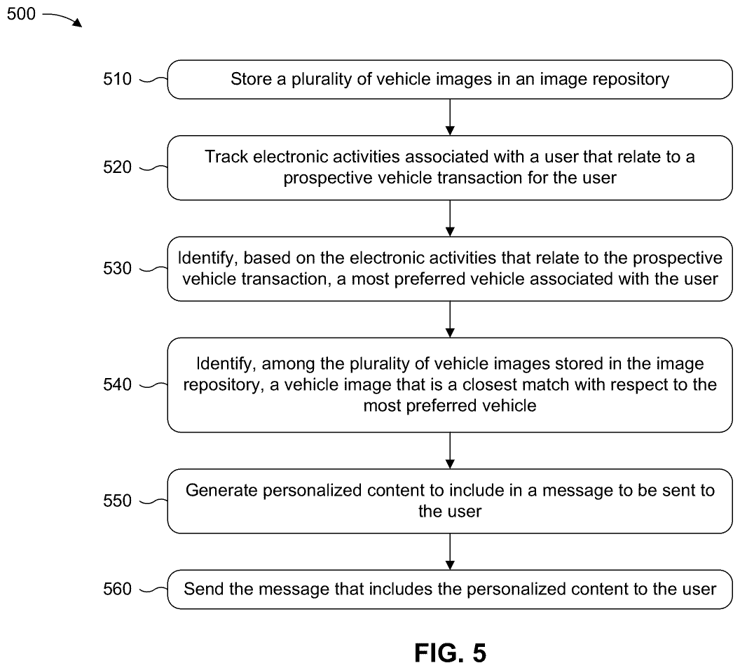

FIG. 5 is a flowchart of an example process 500 associated with personalized vehicle content including a vehicle image based on a most preferred vehicle, in accordance with some embodiments of the present disclosure. In some implementations, one or more process blocks of FIG. 5 may be performed by the personalization system 360. In some implementations, one or more process blocks of FIG. 5 may be performed by another device or a group of devices separate from or including the personalization system 360, such as the client device 310, the web server 340, the extension server 350, and/or the image repository 370. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include storing a plurality of vehicle images in an image repository (block 510). For example, the personalization system 360 (e.g., using processor 420 and/or memory 430) may store a plurality of vehicle images in an image repository, as described above in connection with reference numbers 125 and 130 of FIG. 1B. As an example, the personalization system may store various stock images or other suitable images that depict vehicles associated with different attributes or combinations of attributes, which may include a year, a make, a model, a trim level, a color, and/or other suitable attributes associated with a vehicle depicted in each respective image.

As further shown in FIG. 5, process 500 may include tracking electronic activities associated with a user that relate to a prospective vehicle transaction for the user (block 520). For example, the personalization system 360 (e.g., using processor 420 and/or memory 430) may track electronic activities associated with a user that relate to a prospective vehicle transaction for the user, as described above in connection with reference numbers 105, 110, and/or 115 of FIG. 1A. As an example, a user may interact with a client device to model a vehicle loan, obtain prequalification or preapproval for a vehicle loan, conduct research into different vehicles, and/or otherwise engage in electronic activities that may relate to a prospective vehicle transaction (e.g., a vehicle loan or a vehicle lease), and such electronic activities may be tracked by the personalization system to determine preferences of the user with respect to one or more vehicles.

As further shown in FIG. 5, process 500 may include identifying, based on the electronic activities that relate to the prospective vehicle transaction, a most preferred vehicle associated with the user (block 530). For example, the personalization system 360 (e.g., using processor 420 and/or memory 430) may identify, based on the electronic activities that relate to the prospective vehicle transaction, a most preferred vehicle associated with the user, as described above in connection with reference number 120 of FIG. 1A. As an example, the personalization system may identify a set of one or more vehicles that the user may be interested in purchasing or leasing based on the tracked electronic activities of the user, and the preferences of the user may be analyzed to identify one vehicle or set of vehicle attributes corresponding to a vehicle that the user most prefers in connection with a prospective transaction (e.g., a vehicle associated with a combination of year, make, model, trim level, and color attributes).

As further shown in FIG. 5, process 500 may include identifying, among the plurality of vehicle images stored in the image repository, a vehicle image that is a closest match with respect to the most preferred vehicle (block 540). For example, the personalization system 360 (e.g., using processor 420 and/or memory 430) may identify, among the plurality of vehicle images stored in the image repository, a vehicle image that is a closest match with respect to the most preferred vehicle, as described above in connection with reference numbers 125 and 130 of FIG. 1B. As an example, the tracked electronic activities of the user may indicate that the vehicle most preferred by the user is a relatively recent used vehicle having a specific make, model, trim level, and color, and the personalization system may search the image repository for an image that depicts a vehicle matching the year, make, model, trim level, and color of the vehicle most preferred by the user. In cases where such an image is found, the vehicle image that is a closest match with respect to the most preferred vehicle may correspond to the image depicting the vehicle matching the year, make, model, trim level, and color of the vehicle most preferred by the user. Additionally, or alternatively, in cases where there is no image depicting a vehicle matching the year, make, model, trim level, and color of the vehicle most preferred by the user, the personalization system may search for images depicting vehicles associated with a subcombination of features that matches the year, make, model, trim level, and color of the vehicle most preferred by the user, and one such image may be identified as the closest match. Additionally, or alternatively, the personalization system may use machine learning or artificial intelligence techniques or other suitable search algorithms to identify the image depicting a vehicle that is the closest match for the vehicle that is most preferred by the user.

As further shown in FIG. 5, process 500 may include generating personalized content to include in a message to be sent to the user, wherein the personalized content includes the vehicle image that is the closest match with respect to the most preferred vehicle (block 550). For example, the personalization system 360 (e.g., using processor 420 and/or memory 430) may generate personalized content to include in a message to be sent to the user, wherein the personalized content includes the vehicle image that is the closest match with respect to the most preferred vehicle, as described above in connection with reference number 135 of FIG. 1B. In some implementations, the personalized content includes the vehicle image that is the closest match with respect to the most preferred vehicle. As an example, the message may include an email, a text message, a browser notification, an application-specific notification, and/or another suitable message that includes content related to one or more vehicles that the user may have an interest in purchasing or leasing (e.g., an offer of promotional financing, cash back, dealer incentives, or other suitable content), and the message may include the image that was identified as the closest match with respect to the vehicle that is most preferred by the user.

As further shown in FIG. 5, process 500 may include sending the message that includes the personalized content to the user (block 560). For example, the personalization system 360 (e.g., using processor 420, memory 430, and/or communication component 460) may send the message that includes the personalized content to the user, as described above in connection with reference number 135 of FIG. 1B. As an example, the personalization system may send, to the client device, an email, a text message, a browser notification, an application-specific notification, and/or another suitable message that includes the image that was identified as the closest match with respect to the vehicle that is most preferred by the user.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1B. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A system for providing personalized vehicle content, the system comprising:
one or more memories; and
one or more processors, communicatively coupled to the one or more memories, configured to:
store a plurality of vehicle images in an image repository;
track electronic activities associated with a user that relate to a prospective vehicle transaction for the user;
determine, based on tracking the electronic activities that relate to the prospective vehicle transaction, one or more vehicle attributes;
generate, based on applying an influence factor to the one or more vehicle attributes, a weighted feature dataset, wherein the weighted feature dataset is represented as a vehicle feature vector that includes an array of elements associated with the one or more vehicle attributes;
identify, based on inputting the weighted feature dataset into a machine learning model, a most preferred vehicle associated with the user;
identify, among the plurality of vehicle images stored in the image repository, a vehicle image that is a closest match with respect to the most preferred vehicle using computer vision techniques to derive one or more attributes associated with the plurality of vehicle images;
generate, using the machine learning model and based on identifying the vehicle image that is the closest match with the closest match with respect to the most preferred vehicle, personalized content to include in a message to be sent to the user,
wherein the personalized content includes the vehicle image that is the closest match with respect to the most preferred vehicle; and
send the message that includes the personalized content to the user.

2. The system of claim 1, wherein the one or more processors, to identify the vehicle image that is the closest match with respect to the most preferred vehicle using computer vision techniques to derive one or more attributes associated with the plurality of vehicle images stored in the image repository, are configured to:
determine, using the computer vision techniques and for each of the plurality of vehicle images, a combination of features associated with a vehicle depicted in the respective vehicle image,
wherein the vehicle image that is the closest match with respect to the most preferred vehicle is identified based on the combination of features associated with the vehicle image being an exact match with respect to a combination of attributes associated with the most preferred vehicle.

3. The system of claim 1, wherein the one or more processors, to identify the vehicle image that is the closest match with respect to the most preferred vehicle using computer vision techniques to derive one or more attributes associated with the plurality of vehicle images, are configured to:
determine that the plurality of vehicle images do not include a vehicle image associated with a combination of features that is an exact match with respect to a combination of attributes associated with the most preferred vehicle; and
search the plurality of vehicle images for a vehicle image associated with a prioritized subcombination of features that is an exact match with respect to a prioritized subcombination of the combination of attributes associated with the most preferred vehicle,
wherein the vehicle image that is the closest match with respect to the most preferred vehicle is identified based on the prioritized subcombination of features associated with the vehicle image being an exact match with respect to the prioritized subcombination of the combination of attributes associated with the most preferred vehicle.

4. The system of claim 3, wherein a set of features included in the prioritized subcombination of features associated with the vehicle image and the prioritized subcombination of the combination of attributes associated with the most preferred vehicle does not include one or more of a year, a make, a model, a trim, or a color.

5. The system of claim 1, wherein the one or more processors, to identify the vehicle image that is the closest match with respect to the most preferred vehicle using computer vision techniques to derive one or more attributes associated with the plurality of vehicle images, are configured to:
determine that the plurality of vehicle images include multiple vehicle images associated with a combination or subcombination of features that is an exact match with respect to a combination or subcombination of attributes associated with the most preferred vehicle; and
identify, as the vehicle image that is the closest match with respect to the most preferred vehicle, one of the multiple vehicle images that has a highest resolution.

6. The system of claim 1, wherein the one or more processors are configured to identify the vehicle image that is the closest match with respect to the most preferred vehicle using the computer vision techniques and based on a combination of attributes associated with the most preferred vehicle and combinations of features associated with vehicles depicted in the plurality of vehicle images.

7. The system of claim 1, wherein the one or more processors, to identify the vehicle image that is the closest match with respect to the most preferred vehicle using computer vision techniques to derive one or more attributes associated with the plurality of vehicle images, are configured to:
identify, as the vehicle image that is the closest match with respect to the most preferred vehicle, a default image associated with a combination of attributes associated with the most preferred vehicle based on none of the plurality of vehicle images being associated with a feature that matches an attribute associated with the most preferred vehicle.

8. The system of claim 1, wherein the message is an email message, a text message, a direct mail communication, a web notification, or an application-specific message.

9. A method for generating personalized content, comprising:
tracking, by a personalization system, electronic activities associated with a user that relate to a prospective vehicle transaction for the user;
determining, by the personalization system and based on tracking the electronic activities that relate to the prospective vehicle transaction, one or more vehicle attributes;
generating, by the personalization system and based on applying an influence factor to the one or more vehicle attributes, a weighted feature dataset, wherein the weighted feature dataset is represented as a vehicle feature vector that includes an array of elements associated with the one or more vehicle attributes;
identifying, by the personalization system and based on inputting the weighted feature dataset into a machine learning model, a most preferred vehicle associated with the user;
identifying, by the personalization system, among a plurality of vehicle images stored in an image repository, a vehicle image that is a closest match with respect to the most preferred vehicle using computer vision techniques to derive one or more attributes associated with the plurality of vehicle images; and
generating, by the personalization system, using the machine learning model, and based on identifying the vehicle image that is the closest match with the closest match with respect to the most preferred vehicle, personalized content to include in a message to be sent to the user,
wherein the personalized content includes the vehicle image that is the closest match with respect to the most preferred vehicle.

10. The method of claim 9, wherein identifying the vehicle image that is the closest match with respect to the most preferred vehicle using computer vision techniques to derive one or more attributes associated with the plurality of vehicle images comprises:
determining, using the computer vision techniques and for each of the plurality of vehicle images, a combination of features associated with a vehicle depicted in the respective vehicle image,
wherein the vehicle image that is the closest match with respect to the most preferred vehicle is identified based on the combination of features associated with the vehicle image being an exact match with respect to a combination of attributes associated with the most preferred vehicle.

11. The method of claim 9, wherein identifying the vehicle image that is the closest match with respect to the most preferred vehicle using computer vision techniques to derive one or more attributes associated with the plurality of vehicle images comprises:
determining that the plurality of vehicle images do not include a vehicle image associated with a combination of features that is an exact match with respect to a combination of attributes associated with the most preferred vehicle; and
searching the plurality of vehicle images for a vehicle image associated with a prioritized subcombination of features that is an exact match with respect to a prioritized subcombination of the combination of attributes associated with the most preferred vehicle,
wherein the vehicle image that is the closest match with respect to the most preferred vehicle is identified based on the prioritized subcombination of features associated with the vehicle image being an exact match with respect to the prioritized subcombination of the combination of attributes associated with the most preferred vehicle.

12. The method of claim 9, wherein identifying the vehicle image that is the closest match with respect to the most preferred vehicle using computer vision techniques to derive one or more attributes associated with the plurality of vehicle images comprises:
determining that the plurality of vehicle images include multiple vehicle images associated with a combination or subcombination of features that is an exact match with respect to a combination or subcombination of attributes associated with the most preferred vehicle; and
identifying, as the vehicle image that is the closest match with respect to the most preferred vehicle, one of the multiple vehicle images that has a highest resolution.

13. The method of claim 9, comprising identifying the vehicle image that is the closest match with respect to the most preferred vehicle using the computer vision techniques and based on a combination of attributes associated with the most preferred vehicle and combinations of features associated with vehicles depicted in the plurality of vehicle images.

14. The method of claim 9, wherein identifying the vehicle image that is the closest match with respect to the most preferred vehicle using computer vision techniques to derive one or more attributes associated with the plurality of vehicle images comprises:
identifying, as the vehicle image that is the closest match with respect to the most preferred vehicle, a default image associated with a combination of attributes associated with the most preferred vehicle based on none of the plurality of vehicle images being associated with a feature that matches an attribute associated with the most preferred vehicle.

15. A non-transitory computer-readable medium storing a set of instructions, the set of instructions comprising:
one or more instructions that, when executed by one or more processors of a system, cause the system to:
track electronic activities associated with a user that relate to a prospective vehicle transaction for the user;
determine, based on tracking the electronic activities that relate to the prospective vehicle transaction, one or more vehicle attributes;
generate, based on applying an influence factor to the one or more vehicle attributes, a weighted feature dataset, wherein the weighted feature dataset is represented as a vehicle feature vector that includes an array of elements associated with the one or more vehicle attributes;
identify, based on inputting the weighted feature dataset into a machine learning model, a most preferred vehicle associated with the user;
search, using computer vision techniques, for a vehicle image that is a closest match with respect to the most preferred vehicle;
generate, using the machine learning model and based on identifying the vehicle image that is the closest match with the closest match with respect to the most preferred vehicle, personalized content to include in a message to be sent to the user,
wherein the personalized content includes the vehicle image that is the closest match with respect to the most preferred vehicle; and
send the message that includes the personalized content to the user.

16. The non-transitory computer-readable medium of claim 15, wherein the one or more instructions, that cause the system to search for the vehicle image that is the closest match with respect to the most preferred vehicle, cause the system to:
determine, for each of a plurality of vehicle images, a combination of features associated with a vehicle depicted in the respective vehicle image,
wherein the vehicle image that is the closest match with respect to the most preferred vehicle is identified based on the combination of features associated with the vehicle image being an exact match with respect to a combination of attributes associated with the most preferred vehicle.

17. The non-transitory computer-readable medium of claim 15, wherein the one or more instructions, that cause the system to search for the vehicle image that is the closest match with respect to the most preferred vehicle, cause the system to:
determine that a plurality of vehicle images do not include a vehicle image associated with a combination of features that is an exact match with respect to a combination of attributes associated with the most preferred vehicle; and
search the plurality of vehicle images for a vehicle image associated with a prioritized subcombination of features that is an exact match with respect to a prioritized subcombination of the combination of attributes associated with the most preferred vehicle,
wherein the vehicle image that is the closest match with respect to the most preferred vehicle is identified based on the prioritized subcombination of features associated with the vehicle image being an exact match with respect to the prioritized subcombination of the combination of attributes associated with the most preferred vehicle.

18. The non-transitory computer-readable medium of claim 15, wherein the one or more instructions, that cause the system to search for the vehicle image that is the closest match with respect to the most preferred vehicle, cause the system to:
identify multiple vehicle images associated with a combination or subcombination of features that is an exact match with respect to a combination or subcombination of attributes associated with the most preferred vehicle; and
identify, as the vehicle image that is the closest match with respect to the most preferred vehicle, one of the multiple vehicle images that has a highest resolution.

19. The non-transitory computer-readable medium of claim 15, wherein the one or more instructions further cause the system to search for the vehicle image that is the closest match with respect to the most preferred vehicle using a machine learning model based on a combination of attributes associated with the most preferred vehicle and combinations of features associated with vehicles depicted in a plurality of vehicle images.

20. The non-transitory computer-readable medium of claim 15, wherein the one or more instructions, that cause the system to search for the vehicle image that is the closest match with respect to the most preferred vehicle, cause the system to:
identify, as the vehicle image that is the closest match with respect to the most preferred vehicle, a default image associated with a combination of attributes associated with the most preferred vehicle based on none of a plurality of vehicle images being associated with a feature that matches an attribute associated with the most preferred vehicle.
